(19) United States
(12) Patent Application Publication
(10) Pub. No.: US 2016/0069458 A1
(43) Pub. Date: Mar. 10, 2016

(54) HUB ASSEMBLY FOR A MARINE VESSEL PROPULSION UNIT INCLUDING A SPLINE SEAL

(71) Applicant: Schaeffler Technologies AG & Co. KG, Herzogenaurach (DE)

(72) Inventors: Daniel PATIÑO CRESPO, Puebla (MX); Raymundo JUAN LIEN CHANG, San Pedro Cholula (MX)

(21) Appl. No.: 14/845,092

(22) Filed: Sep. 3, 2015

Related U.S. Application Data
(60) Provisional application No. 62/047,532, filed on Sep. 8, 2014.

(51) Int. Cl. F16J 15/54; F16F 15/134; F16F 15/315; F16D 3/12

(52) U.S. Cl. CPC F16J 15/54; F16D 3/12; F16F 15/134; F16F 15/315; F16D 2300/08

(57) ABSTRACT

A hub assembly for a marine vessel propulsion unit is provided. The hub assembly includes a hub having a splined inner circumferential surface including first axially aligned splines and a further inner circumferential surface radially offset from the splined inner circumferential surface. The hub assembly also includes a seal held by the further inner circumferential surface. The seal includes a splined inner circumferential seal surface having second axially aligned splines aligned with the first axially aligned splines.

This claims the benefit to U.S. Provisional Patent Application No. 62/047,532 filed Sep. 8, 2014, which is hereby incorporated by reference herein.

The present disclosure relates generally to splined hubs and more specifically to splined damper hubs for marine vessel propulsion units.

### BACKGROUND

Conventionally, rubber bellows have been fixed to the outside of hubs with clamp springs to seal mechanical unions.

### SUMMARY OF THE INVENTION

A hub assembly for a marine vessel propulsion unit is provided. The hub assembly includes a hub having a splined inner circumferential surface including first axially aligned splines and a further inner circumferential surface radially offset from the splined inner circumferential surface. The hub assembly also includes a seal held by the further inner circumferential surface. The seal includes a splined inner circumferential seal surface having second axially aligned splines aligned with the first axially aligned splines.

A drive assembly for a marine vessel propulsion unit is also provided that includes the hub assembly and a damper rotationally fixed to an outer circumferential surface of the hub.

A method for forming a hub assembly for a marine vessel propulsion unit is also provided. The method includes providing a hub having a splined inner circumferential surface including first axially aligned splines and a further inner circumferential surface radially offset from the splined inner circumferential surface; and axially inserting a seal into the further inner circumferential surface. The seal includes a splined inner circumferential seal surface having second axially aligned splines aligned with the first axially aligned splines.

### BRIEF DESCRIPTION OF THE DRAWINGS

The present invention is described below by reference to the following drawings, in which:

FIG. 1 shows a cross-sectional side view of a drive assembly for a marine vessel propulsion unit according to an embodiment of the present invention;

FIG. 2a shows an enlarged cross-sectional perspective view of a transmission side of a hub assembly in accordance with an embodiment of the present invention;

FIG. 2b shows an enlarged cross-sectional side view of the transmission side of the hub assembly shown in FIG. 2a;

FIG. 3a shows a perspective view of a transmission shaft inside of the hub assembly of FIGS. 2a and 2b;

FIG. 3b shows a cross-sectional side view of the transmission shaft inside of the hub assembly of FIGS. 2a and 2b; and

FIGS. 4a to 4c shows views illustrating a hub assembly in accordance with an alternative embodiment of the present invention.

### DETAILED DESCRIPTION

The present disclosure provides a molded rubber seal design for a splined shaft. The seal is used to seal the shaft to a damper assembly to retain grease in the hub in a marine environment. The seal includes a conical outer surface that is retained by a complementary shape formed on an inner circumference of the hub, and a splined inner surface for sealing to the shaft. Alignment of the seal splines to the hub splines may be a concern, so an alignment tab or notch between the seal and hub may be provided.

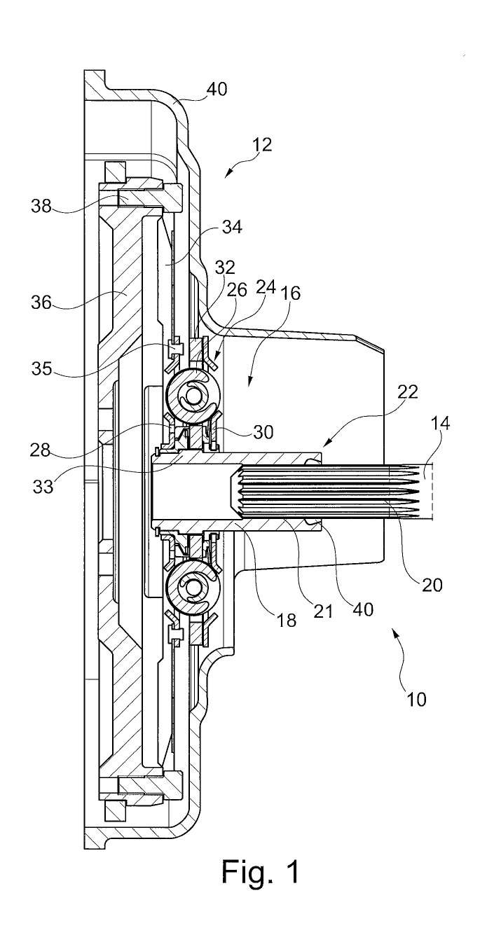

FIG. 1 shows a cross-sectional side view of a drive assembly 10 for a marine vessel propulsion unit according to an embodiment of the present invention. Drive assembly 10 includes a flywheel assembly 12 connected to a transmission input shaft 14 by a hub assembly 16. More specifically, drive assembly 10 is connected to transmission input shaft 14 by a connection between a hollow hub 18 of hub assembly 16. In a preferred embodiment, hub 18 is formed of metal, more preferably stainless steel. Transmission input shaft 14 extends partially into hub 18 at a transmission side 22 of hub 18. Input shaft 14 includes a splined outer circumferential surface 20 that drivingly engages a splined inner circumferential surface 21 of hub 18.

Hub assembly 16 further includes a damper 24 formed by springs 26 received between two cover plates 28, 30. A flange 32 drivingly connected to teeth 33 on an outer circumferential surface of hub 18 is provided between cover plates 28, 30. Flange 32 includes a plurality of circumferential extending spaces formed therein for receiving springs 26. Damper 24 further includes a spring plate 34 for connecting damper 24 to a flywheel 36. Spring plate 34 at a radial inner end thereof is fixed to cover plate 28 by rivets 35 and at a radial outer end is fixed to flywheel 36 by fasteners 38. Flywheel assembly 12 further includes a cover 40 surrounding flywheel 36 and hub assembly 16. Flywheel 36 is configured for connection to a crankshaft of an engine. Torque from the engine is transmitted by flywheel 36 to spring plate 34, which transfers the torque to cover plates 28, 30. Cover plates 28, 30 in turn transfer the torque to springs 26, which circumferentially drive flange 32 to rotate hub 18. Hub 18, via the splined connection with transmission input shaft 14, drives transmission input shaft 14.

A seal 40, which in a preferred embodiment is a molded rubber seal, is provided at transmission side 22 of hub 18 to advantageously prevent grease provided inside hub 18 at the interface of splined surfaces 20, 21 from flowing axially out of hub 18 during the operation of drive assembly 10 into the transmission.

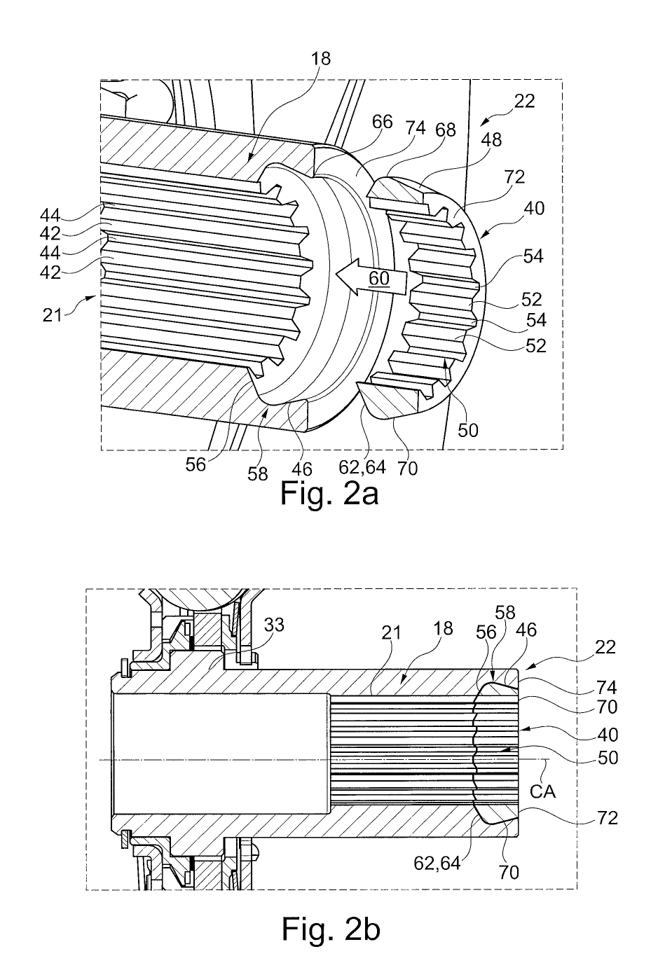

FIG. 2a shows an enlarged cross-sectional perspective view of transmission side 22 of hub assembly 16 with seal 40 being separate from hub 18; and FIG. 2b shows an enlarged cross-sectional side view of transmission side 22 of hub assembly 16 with seal 40 inserted inside hub 18. Splined inner circumferential surface 21 of hub 18 includes first axially aligned splines 42 that are separated from each other by a plurality of axially aligned grooves 44. Hub 18 also includes a further inner circumferential surface 46 radially offset from splined inner circumferential surface 21. As shown in FIG. 2a, further inner circumferential surface 46 is smooth and is not splined in this embodiment. Seal 40 is held within hub 18 by further inner circumferential surface 46. In this embodiment, further inner circumferential surface 46 contacts a smooth outer circumferential surface 48 of seal 40. Seal 40 includes a splined inner circumferential seal surface 50 having second axially aligned splines 52 aligned with the first axially aligned splines 42. Similar to splines 42, splines 52 are separated from each other by a plurality of axially aligned grooves 54, which are aligned with axially aligned groove 44 of hub 18. Accordingly, when seal 40 is inserted in hub 18, seal 40 and hub 18 define a contiguous splined inner circumferential surface.

As shown in FIG. 2b, further inner circumferential surface 46 is angled at an acute angle with respect to a center axis CA of the hub 18. The inner circumference of hub 18 also includes a radially extending surface 56 connecting splined inner circumferential surface 21 and further inner circumferential surface 46. Radially extending surface 56 is also angled at an acute angle with respect to center axis CA of the hub 18. Together, radially extending surface 56 and further inner circumferential surface 46 define an annular groove 58 for securing seal 40 inside of hub 18 during the operation of drive assembly 10.

As shown in FIG. 2a by arrow 60, assembling hub assembly 16 involves axially inserting seal 40 into further inner circumferential surface 46 of hub 18 such that second axially aligned splines 52 are aligned with first axially aligned splines 42 and second axially aligned grooves 54 are aligned with first axially aligned grooves 44. During the axially inserting, a radially extending surface 62 forming a leading axial edge 64 of seal 40 is pressed against an axially outer edge 66 of further inner circumferential surface 46 forming an innermost diameter of the further inner circumferential surface 46. Seal 40 deforms slightly radially inward until axial outer edge 66 of passes over an outermost diameter 68 of seal 40. Accordingly, the axially inserting includes pressing outermost diameter 68 of outer circumferential surface 48 of seal 40 through the innermost diameter of further inner circumferential surface 46 at axial outer edge 66. After outermost diameter 68 passes axial outer edge 66 and enters into groove 58, a frustoconical surface 70 of seal 40, which converges toward a trailing or outer axial edge 72 of seal 40, passes through axial outer edge 66 until axial outer edge 66 aligns with outer axial edge 72 of seal 40, which also aligns with an axial end 74 of hub 18. Once seal 40 is fully inserted in hub 18 at groove 58, radially extending surface 62 mates with radially extending surface 56 and frustoconical surface 70 mates with further inner circumferential surface 46, which also has a frustoconical shape.

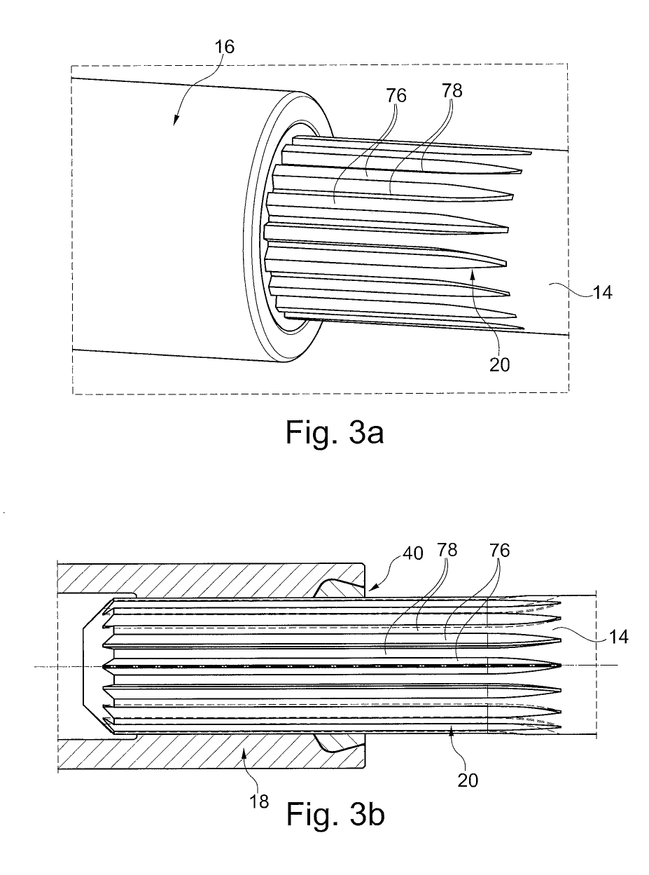

FIG. 3a shows a perspective view of transmission shaft 14 inside of hub assembly 16; and FIG. 3b shows a cross-sectional side view of transmission shaft 14 inside of hub assembly 16. Splined outer circumferential surface 20 of transmission shaft 14 includes axially aligned splines 76 that are separated from each other by a plurality of axially aligned grooves 78. Splined outer circumferential surface 20 of transmission shaft 14 is held by splined inner circumferential seal surface 50 of seal 40 and splined inner circumferential seal surface 21 of hub 18 such that axially aligned splines 76 of transmission shaft 14 are received in axially aligned grooves 54 of seal 40 and axially aligned grooves 44 of hub 18, and axially aligned splines 52 of seal 40 and axially aligned splines 42 of hub 18 are received in axially aligned grooves 78 of transmission shaft 14.

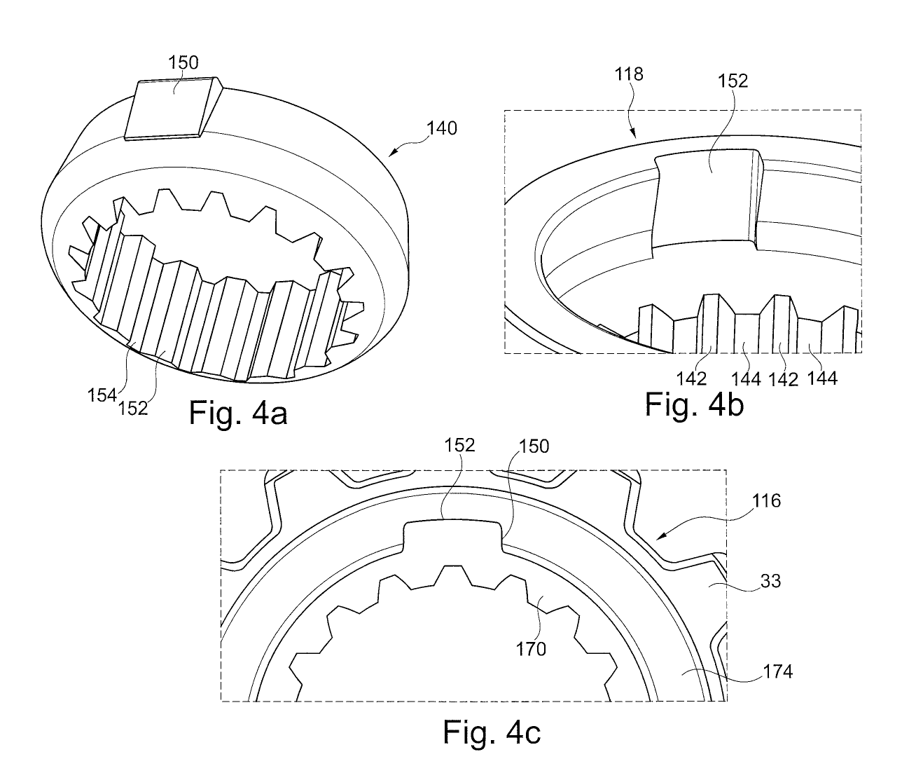

FIGS. 4a to 4c shows views illustrating a hub assembly 116 in accordance with an alternative embodiment of the present invention. Hub assembly 116 is formed in the same manner as hub assembly 16, except that a seal 140 of hub assembly 116 includes an axially and radially extending projection 150 and a hub 118 of hub assembly 116 includes an axially and radially extending notch 152 formed therein. Notch 152 and projection 150 have matching shapes for mating. When seal 140 is inserted into hub 118, projection 150 is inserted into notch 152 to ensure a proper rotational alignment of splined inner surfaces of hub 118 and seal 140 (i.e., splines 142 and splines 152 are aligned and grooves 144 and splines 154 are aligned), such that seal 140 does not rotate with respect to hub 118. As shown in FIG. 4c, at an axial outer edge 170 of seal 140 and an axial outer end 174 of hub 118, projection 150 extends radially into notch 152. In this embodiment, axially inserting seal 140 into hub 118 includes aligning notch 152 and projection 150 and inserting seal 140 into hub 118 such that projection 150 is held in notch 152 to prevent rotational movement of seal 140.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A hub assembly for a marine vessel propulsion unit comprising:
a hub having a splined inner circumferential surface including first axially aligned splines and a further inner circumferential surface radially offset from the splined inner circumferential surface; and
a seal held by the further inner circumferential surface, the seal including a splined inner circumferential seal surface having second axially aligned splines aligned with the first axially aligned splines.

2. The hub assembly as recited in claim 1 wherein the hub is formed of metal and the seal is formed of rubber.

3. The hub assembly as recited in claim 1 wherein the further inner circumferential surface is angled at an acute angle with respect to a center axis of the hub.

4. The hub assembly as recited in claim 3 wherein the hub further includes a radially extending surface connecting the splined inner circumferential surface and the further inner circumferential surface.

5. The hub assembly as recited in claim 4 wherein the radially extending surface is angled at an acute angle with respect to a center axis of the hub.

6. The hub assembly as recited in claim 5 wherein the radially extending surface and the further inner circumferential surface define an annular groove.

7. The hub assembly as recited in claim 1 wherein the further inner circumferential surface includes a notch formed therein.

8. The hub assembly as recited in claim 7 wherein the seal includes an outer circumferential surface including a projection, the projection being held in the notch to prevent rotational movement of the seal.

9. A drive assembly comprising:
the hub assembly as recited in claim 1; and
a damper rotationally fixed to an outer circumferential surface of the hub.

10. The drive assembly as recited in claim 9 further comprising a flywheel fixed to the damper configured for transferring torque from an engine to the damper hub via the damper.

11. The drive assembly as recited in claim 10 further comprising a transmission input shaft rotationally fixed to the splined inner circumferential surface and the splined inner circumferential seal surface.

12. A method of forming a sealed hub assembly for a marine vessel propulsion unit comprising:
providing a hub having a splined inner circumferential surface including first axially aligned splines and a further inner circumferential surface radially offset from the splined inner circumferential surface; and
axially inserting a seal into the further inner circumferential surface, the seal including a splined inner circumferential seal surface having second axially aligned splines aligned with the first axially aligned splines.

13. The method as recited in claim 12 wherein the further inner circumferential surface includes an axial edge forming an innermost diameter of the further inner circumferential surface and the seal includes an outer circumferential surface having an outermost diameter, the axially inserting including pressing the outermost diameter of the outer circumferential surface of the seal through the innermost diameter of the axial edge of the further inner circumferential surface of the hub.

14. The method as recited in claim 12 wherein the further inner circumferential surface is angled at an acute angle with respect to a center axis of the hub, the seal including an outer circumferential surface having a matching contour to the further inner circumferential surface, the axially inserting including mating the further inner circumferential surface and the outer circumferential surface.

15. The method as recited in claim 14 wherein the further inner circumferential surface includes a notch formed therein and the outer circumferential surface of the seal includes a projection, the axially inserting including aligning the notch and the projection and inserting the seal into the hub such that the projection is held in the notch to prevent rotational movement of the seal.

16. The method as recited in claim 12 wherein the hub further includes a radially extending surface connecting the splined inner circumferential surface and the further inner circumferential surface, the axially inserting including pressing the seal into the hub until a leading axial edge of the seal contacts the radially extending surface.
